(19) United States
(12) Patent Application Publication
(10) Pub. No.: US 2006/0064339 A1
(43) Pub. Date: Mar. 23, 2006

(54) Methods and systems for conducting internet marketing experiments

(75) Inventor: Chad R. Allred, Highland, UT (US)

Correspondence Address: STOEL RIVES LLP;Suite 1100, 201 South Main Street, One Utah Center, Salt Lake City, UT, 84111, US

(73) Assignee: Technology Transfer Office, Brigham Young University

(21) Appl. No.: 11/225,694

(22) Filed: Sep. 13, 2005

Related U.S. Application Data
(60) Provisional application No. 60/609,584, filed on Sep. 13, 2004.
(60) Provisional application No. 60/671,717, filed on Apr. 14, 2005.

(51) Int. Cl. G06F 15/02

(52) U.S. Cl. 705/9

(57) ABSTRACT

A system for conducting experiments over the Internet and related methods are disclosed. The system may be modular and include an experiment design engine to construct an experiment over designated web pages. A distributed experiment control engine may execute the experiment design constructed by the design engine. Desired user behavior in response to each possible experimental path is recorded. The data recorded and the experiment design may be stored on an experiment database. The system may also include a web page parsing engine to configure a designated web page for experimentation. The system may also include an experiment analysis engine to analyze experiments and an optimization engine to determine which experimental path is optimum upon conducting the experiment.

### RELATED APPLICATIONS

This application claims the benefit of U.S. Provisional Patent Application Ser. No. 60/609,584, filed Sep. 13, 2004, entitled EXPERIMENT AND OPTIMIZATION PLATFORM AND TOOLKIT METHOD AND CONCEPTUAL DESIGN, and U.S. Provisional Patent Application Ser. No. 60/671,717, filed Apr. 14, 2005, entitled EXPERIMENT AND OPTIMIZATION PLATFORM AND TOOLKIT METHOD AND CONCEPTUAL DESIGN, both of which are incorporated herein by reference.

### BRIEF DESCRIPTION OF THE DRAWINGS

The embodiments disclosed herein will become more fully apparent from the following description and appended claims, taken in conjunction with the accompanying drawings. These drawings depict only typical embodiments, which will be described with additional specificity and detail through use of the accompanying drawings in which:

FIG. 1 is a block diagram of one embodiment of a system for conducting experiments over the Internet;

FIG. 2 is a block diagram of one embodiment of an experiment design engine;

FIG. 3 is a flow diagram of one embodiment of a method for parsing web pages;

FIG. 4 is a flow diagram of one embodiment of a method for creating an experimental design;

FIG. 5 is a flow diagram of one embodiment of a method for conducting an experiment according to an experimental design;

FIG. 6 is a flow diagram of one embodiment of a method for analyzing experiments as they are being conducted;

FIG. 7 is a flow diagram of one embodiment of a method for optimizing experimental paths in an experimental design;

FIG. 8 is a block diagram of one embodiment of an experience design tree of an experimental design; and

FIG. 9 is a block diagram of one embodiment of an event design tree of an experimental design.

### DETAILED DESCRIPTION

Reference is now made to the figures in which, for the purpose of clarity, the first digit of a reference numeral indicates the figure number in which the corresponding element is first used. While the various aspects of the embodiments disclosed are presented in drawings, the drawings are not necessarily drawn to scale.

In the following description, numerous specific details of programming, software modules, user selections, network transactions, database queries, database structures, etc., are provided for a thorough understanding of various embodiments of the systems and methods disclosed herein. However, those skilled in the art will recognize that the systems and methods disclosed can be practiced without one or more of the specific details, or with other methods, components, materials, etc.

In some cases, well-known structures, materials, or operations are not shown or described in detail. Furthermore, the described features, structures, or characteristics may be combined in any suitable manner in one or more embodiments. It will also be readily understood that the components of the embodiments as generally described and illustrated in the figures herein could be arranged and designed in a wide variety of different configurations.

The order of the steps or actions of the methods described in connection with the embodiments disclosed may be changed as would be apparent to those skilled in the art. Thus, any order in the figures or detailed description is for illustrative purposes only and is not meant to imply a required order.

Several aspects of the embodiments described will be illustrated as software modules or components. As used herein, a software module or component may include any type of computer instruction or computer executable code located within a memory device and/or transmitted as electronic signals over a system bus or wired or wireless network. A software module may, for instance, comprise one or more physical or logical blocks of computer instructions, which may be organized as a routine, program, object, component, data structure, etc., that performs one or more tasks or implements particular abstract data types.

In certain embodiments, a particular software module may comprise disparate instructions stored in different locations of a memory device, which together implement the described functionality of the module. Indeed, a module may comprise a single instruction, or many instructions, and may be distributed over several different code segments, among different programs, and across several memory devices. Some embodiments may be practiced in a distributed computing environment where tasks are performed by a remote processing device linked through a communications network. In a distributed computing environment, software modules may be located in local and/or remote memory storage devices.

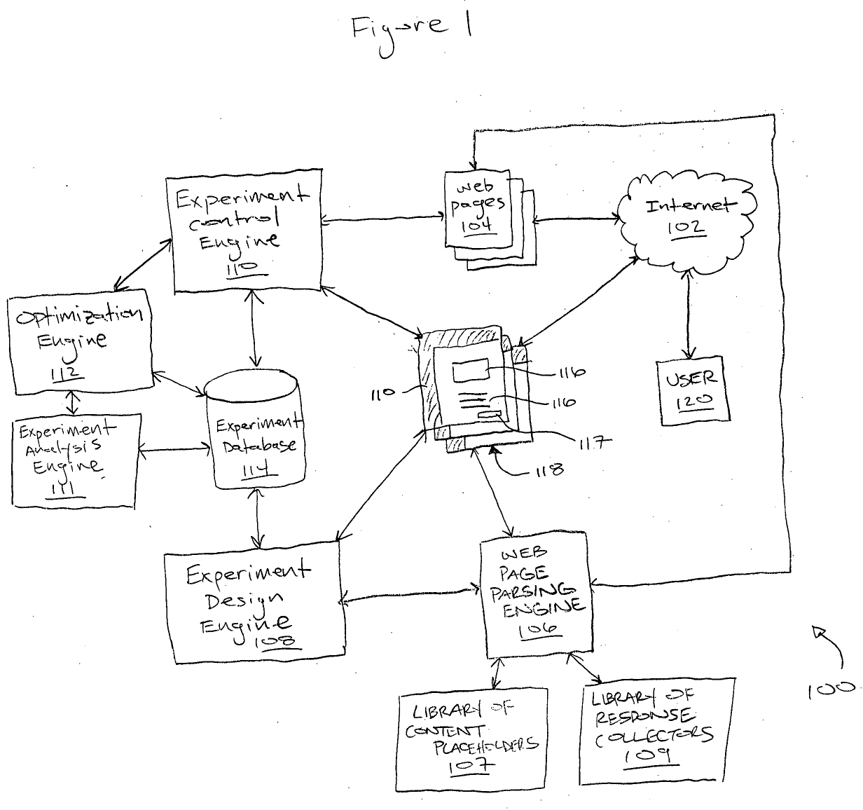

FIG. 1 is a block diagram of one embodiment of a system 100 for conducting experiments over the Internet 102. The embodiment depicted involves experiments using web pages 104. However, experiments may be conducted in alternative applications over the Internet 102, such as email, messaging, chat rooms, etc. Other embodiments of a system for conducting experiments may be administered on other technologically distributed environments, such as wired and wireless communication systems, including but not limited to: (1) phone systems, including data, fax, voice services, etc.; (2) satellite systems, including television and information services, etc.; (3) cable systems, including data and television services, etc.; (4) radio systems, including commercial stations, FRS (Family Radio Service), ham radio, etc.; and (5) transaction systems, such as ATM user interfaces and gas pump user interfaces.

The system 100 for conducting experiments over the Internet 102 are typically in the context of marketing analyses. However, the systems and methods disclosed may also be applied in alternative settings, such as satisfaction in service relationships, psychology experiments, social science experiments, survey responses, information and feedback effectiveness, political interactions, business-to-business transactions and processes, banking and financial transactions, returns authorization, focus group research, web surfing, etc.

The system 100 for conducting experiments over the Internet 102 may utilize established experimentation techniques that are used to test hypothesized cause and effect relationships. For example, a marketing experimenter may desire to know how a particular combination of stimuli in the form of web elements may affect an Internet user's behavior. Various combinations of web elements, such as images, text, audio, video, hyperlinks, etc., may be presented to a pool of users that are randomly assigned to a particular or predefined experience on a given website. User behavior or responses may be measured at predetermined points during the website experience. Statistical inferences may then be drawn about how a particular set of web elements affects an Internet user's behavior.

The system 100 comprises a modular architecture, which may include a web page parsing engine 106, a library of content placeholders 107, a library of response collectors 109, an experiment design engine 108, an experiment control engine 110, an experiment analysis engine 111, an optimization engine 112, and an experiment database 114. The modular architecture may also include content placeholders 116 that may be associated with different web elements/content and response collectors 117 to monitor user behavior.

The web page parsing engine 106 is a utility program that may scan web pages 104 that are identified for use in an experiment. In scanning the web pages 104, the parsing engine 106 identifies the location of potential content placeholders 116 that may be embedded in each of the web pages 104. The content placeholders 116 are containers or locations which define where one of several alternative web elements may appear. For example, if the parsing engine 106 identifies a possible content placeholder 116 that may be associated with graphical images, then the content placeholder 116 may be configured to display one of a group of alternative images during an experiment. Multiple content placeholders 116 may be embedded into a single web page or across several web pages 118. Content placeholders 116 may further contain a combination of web elements, such as marketing offers that include an image and text. A content placeholder 116 may be embodied as code embedded into the web page either automatically through the parsing engine 106 or manually by an experimenter.

The parsing engine 106 may also identify the location of potential response collectors 117 to monitor user behavior that an experimenter may wish to measure. A response collector 117 may be code embedded into the web page either automatically through the parsing engine 106 or manually by an experimenter. In alternative applications, the response collectors 117 and content placeholders 116 may be embedded in devices other than web pages, such as phone systems, television systems, radio systems, and transaction systems, such as ATM user interfaces and gas pump user interfaces. The response collectors 117 of the present embodiment monitor user behavior and record the behavior in the experiment database 114. A response collector 117 may also record contextual information, such as time stamps, computer system information, etc.

Exemplary user behaviors that may be monitored include purchasing of a product or service, the aggregate monetary value of purchases, hyperlink clicks, search behavior, inquiries, bookings and reservations, completion of surveys or questionnaires, other data input, etc. Further aspects of user behavior include the frequency of the behavior and/or the timing of the behavior after presentation of a particular web page. By way of example, the response collector 117 depicted in FIG. 1 may appear to a user 120 as a hyperlink, such that the response collector 117 monitors when the user 120 clicks the hyperlink.

The parsing engine 106 may save a version of the original web pages 104 and then rebuild the web pages 118 to optionally look like the original pages 104. However the rebuilt pages 118 include content placeholders 116 and response collectors 117 that may be selected from a library 107 of content placeholders and a library 109 of response collectors, respectively. The rebuilt web pages 118 are experiment enabled and can be configured to conduct specific experiments over the Internet 102. Experiment enabled content placeholders 116 may be capable of communication with the control engine 110, experiment database 114 and/or the experiment design engine 108. The rebuilt web pages 118 may retain the addresses of the original web pages or receive new addresses to which traffic may be redirected. Experiment enabled content placeholders 116 and response collectors 117 may also be configured directly by the experimenter. The parsing engine 106 may then interface with the experiment design engine 108 to register data about the web pages 118, which may include information about the content placeholders 116 and the response collectors 117, in order to create an experiment design using the rebuilt web pages 118.

The experiment design engine 108 is a utility program that enables an experimenter to create the design of an experiment prior to the experiment's execution. An experiment may be comprised of several events that may be connected through conditional logic and synchronized against a timeline. An event is a content placeholder 116 (or collection of content placeholders 116) and/or a response collector 117 (or collection of response collectors 117) presented to a user 120 at a particular point of time with its associated alternative web elements. Since an event may include a content placeholder 116, the event may represent alternative web elements that may be presented to users 120. The number of unique manifestations of an event is determined by the number of alternative web elements associated with each content placeholder 116. However, in some embodiments an event may be as simple as a single web element associated with a single content placeholder 116.

The experiment design created through the use of the experiment design engine 108 may include multiple experience profiles or experimental paths. An experimental path includes a treatment or a unique configuration of web elements that may be presented to a user 120 that requests the web page 104. An experimental path may comprise a single event, or presentation of a unique web element or set of web elements. In more complex experiments, an experimental path may constitute a series of events (involving multiple web pages 118), which may be linked through conditional logic across a common timeline.

Experimental paths are used to test the impact of alternative web elements on user behavior. Consequently, for a set of alternative web elements, a number of experimental paths may be created by the experiment design engine 108. For example, if a particular web page 118 includes four image placeholders 116, and it is desirable to test the configuration of four different images using these placeholders, a total of twenty-four experimental paths may be created by the experiment design engine 108.

The experiment design engine 108 may allow an experimenter to select which content placeholders 116 should be enabled and identify which alternative web elements are to be associated with each placeholder 116. The experiment design engine 108 may also be used to structure conditional logic between events involving web pages 118, so that events are related to each other in some predetermined manner. Experiment timing, methods of assigning users, construction of control groups, and configuration of data collection methods may all be configured through the experiment design engine 108. The experiment design engine 108 may then push the constructed experiment design out to the experiment database 114.

The experiment database 114 stores a copy of the experiment design. The response collectors 117 also record user response and behavior data to the experiment database 114. The experiment database 114 may also be used to store known information, such as user demographics. This information may be collected prior to execution of the experiment and the information may be associated with a user once they are known during the experiment or after the experiment as derived from questionnaires, interview, etc.

The data may be stored in a centralized database, or alternatively over a distributed environment. The experimental control engine 110 is in electronic communication with the experiment database 114. Additionally, the experiment analysis engine 111, the optimization engine 112 and the content placeholders 116 and response collectors 117 are in electronic communication with the experiment database 114, either directly or indirectly through the experiment control engine 110.

According to one embodiment, once a user 120 requests a web page 104 over the Internet 102, the experiment control engine 110, which may be distributed across several web pages 118, assigns the user 120 to a particular experimental path as designated in the designed experiment. The experiment control engine 110 dynamically presents to the user 120 the pre-defined web elements in accordance with the associated conditional logic of the assigned experimental path. The experiment control engine 110 also may manage information recorded by the response collectors 117.

The functions of the experiment control engine 110 may comprise: (1) recognizing and qualifying users 120 requesting the web page 104; (2) monitoring and managing the experiment timeline of each user 120; (3) checking conditional logic to determine and manage state conditions; (4) interacting with the content placeholders 116 and the experiment database 114; and (5) recording system and user behavior data in the experiment database 114.

The distributed experiment control engine 110 may be embodied as code that is embedded around and into the web pages 118. Code around the web page 118 may intercept HTML calls to the page and screen the user 120. The code within the web page 118 may encapsulate the content placeholders 116 and wait for instructions. Once the user 120 is assigned a treatment or experimental path, the content placeholders 116 present the appropriate content.

The experiment analysis engine 111 is a utility program used to analyze experiments while they are being conducted and after they have been conducted. The experiment analysis engine 111 may be used to determine which statistical methods are most appropriate for analyzing a particular cause and effect relationship between content and user responses. The experiment analysis engine 111 may interface with the experiment database 114 and the optimization engine 112. In alternative embodiments, the experiment analysis engine 111 may also interface with the experiment design engine 108.

The experiment analysis engine 111 may use a variety of optimization algorithms and statistical methods to identify when a conclusion about the experiment can be drawn with a degree of statistical confidence, e.g., OLS regression for continuous response measures, logistic regression for dichotomous objective measures, linear programming, etc. Data are collected for the plurality of experimental paths until a predetermined confidence threshold is achieved, or until the experiment is deemed complete, terminated or re-defined.

The optimization engine 112 is a utility program for identifying the optimum presentation of web elements throughout a system to achieve a particular objective or set of objectives that are being tested in the experiment. The optimization engine 112 may identify which experimental path affects the desired user behavior to the greatest extent. The optimum experimental path may then be maintained as the default web page 104 until new web elements are introduced or a pre-defined time interval has elapsed to conduct the experiment again. The optimization engine 112 may also identify, monitor, and optimize stages within the experimental paths. The optimization engine 112 may be in electronic communication with the experiment database 114, the experiment control engine 110 and the experiment analysis engine 111. In other embodiments, the optimization engine 112 may be in communication with the experiment design engine 108.

The system 100 for conducting experiments over the Internet 102 may further comprise additional modules or elements as would be in keeping with the scope of the disclosure. Moreover, in certain embodiments, various modules may be combined or the functionality of certain modules may be divided among two or more modules.

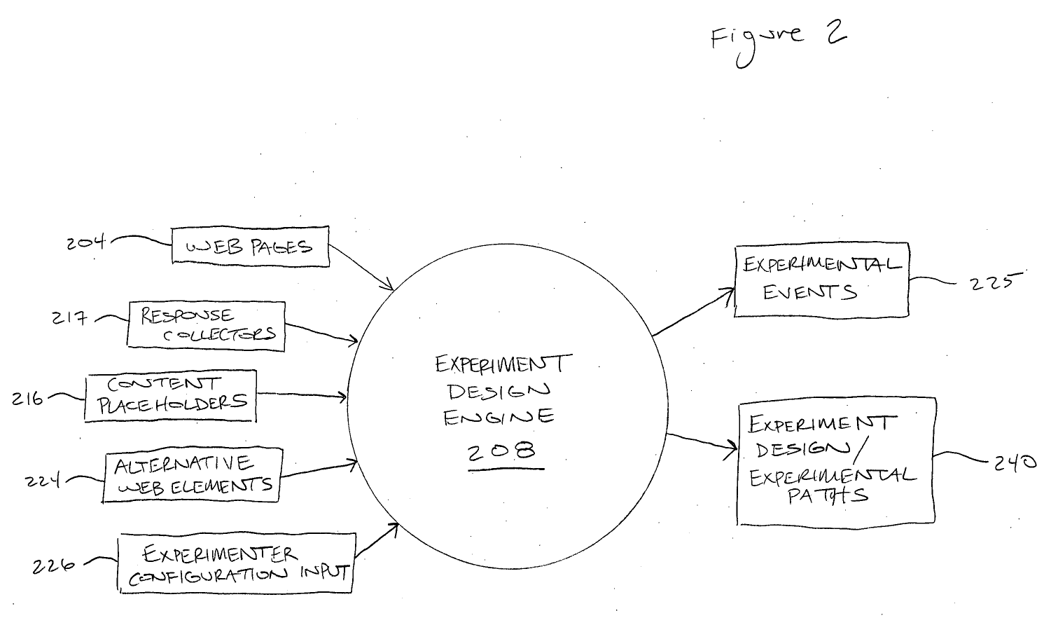

FIG. 2 is a block diagram of one embodiment of an experiment design engine 208 that is part of the system for conducting experiments as described in conjunction with FIG. 1. The experiment design engine 208 is similar to the experiment design engine described in FIG. 1, however, the depicted block diagram illustrates potential inputs and outputs of the experiment design engine 208.

One input to the experiment design engine is the information about the web pages 204 where the experiment is to occur. An experimenter identifies the web pages 204 for experimentation purposes and scans them using the web page parsing engine. Accordingly, the web page 204 input to the experiment design engine 208 may originate from the parsing engine.

The response collectors 217 which monitor and record desired user behavior are also inputted to the experiment design engine 208. The parsing engine may identify and register potential response collectors 217. Alternatively, the experimenter may designate response collectors 217, including the type of user behavior to monitor. Examples of user behavior that may be monitored comprise purchasing of a product or service, the aggregate monetary value of purchases, hyperlink clicks, search behavior, inquiries, bookings and reservations, completion of surveys or questionnaires, other data input, etc. Further aspects of user behavior include the frequency of the behavior and/or the timing of the behavior after presentation of a particular web page.

The selection of response collectors 217 allows the experimenter to specify methods for data collection of user behavior. For instance, the experimenter may measure user behavior in the form of surveys at several points along each experimental path. Measurements or data collection may take place before an event (e.g., presentation of web element), during an event, and/or after the event for all events along the experimental path. Alternatively, data collection may occur at the end of the experimental path. Other forms of data, such as state conditions, time stamps, etc., may also be collected along with the user behavior data.

The parsing engine also identifies the possible location of content placeholders 216 for input to the experiment design engine 208 in an automated fashion. Alternatively, the content placeholders 216 may be embedded manually and then registered with the experiment design engine 208. Using the experiment design engine 208, the experimenter may determine which of the registered content placeholders 216 he desires to enable for the experiment.

The content placeholders 216 are associated with alternative web elements 224 that are inputted to the experiment design engine 208. Exemplary web elements include graphical elements, audio elements, video elements, text elements, and linking elements. Alternative web elements may include alternative types of elements, such as alternative images, but also alternative aspects of the same element. For example, with graphical elements the variations of content, size, color and presentation (e.g., flashing) may constitute a set of web elements. With text elements, the content, size, font, etc., may be experimented with. With audio elements, the content, style, volume, etc., may also be tested.

The experimenter may use the experiment design engine 208 to determine what alternative web elements 224 should be associated with each content placeholder 216. For example, on one hypothetical web page 204, the experimenter may select an image placeholder and a text placeholder. The experimenter may then choose two or three image web elements to be associated with the image placeholder, and two or three text web elements to be associated with the text placeholder. The web elements 224 are typically obtained from an outside source, such as direct experimenter input from content developers.

Upon receiving input from the parsing engine in the form of web pages 204, response collectors 217 and content placeholders 216, and the alternative web elements 224 for each placeholder are identified, the experiment design engine 208 is used to create experimental events 225. As described above, an event is a collection of content placeholders 216 and response collectors 217 at a particular point in time. The experiment design engine 208 is capable of producing multiple events 225 that may be configured relative to each other along a common timeline.

Consequently, the experimenter may provide configuration input 226 such as instructions on how the experiment design engine 208 should arrange and link events 225 relative to each other and across a common timeline. The experiment design engine 208 also performs an automated configuration function separate from, but in conjunction with the experimenter configuration instructions 226.

Experimenter configuration input 226 may comprise how and in what sequence in time web elements are presented to a user in a given experimental path. Configuration 226 input may also comprise conditional logic which identifies how a particular series of events or exposures to a series of web elements unfolds. For example, if on web page #1, a first user sees image #1, then on web page #2 the first user sees text #1 and hyperlink #1. However, if on web page #1, a second user sees image #2, then on web page #2 the second user sees text #2 and hyperlink #2.

Experimenter configuration instructions 226 may also include time domain elements, e.g., how events are linked or associated through time. As events are linked together relative to a timeline, they provide an experience, i.e., a collection of events that are tied logically together against a common timeline. For instance, the sequence between hypothetical Event A and Event B may require that Event A is completed before Event B begins. Another hypothetical condition may state that Event B and Event C occur concurrently.

Alternative time domain elements may include how the calendar date affects the presentation of web elements. For instance, in the context of advertising vacation packages, during winter months a snow skiing image may be displayed. However, during summer months a mountain biking image may be displayed in the same placeholder that the original snow skiing image was displayed. These types of time domain elements may also take into account holidays, days of the week, etc.

The experimenter configuration instructions 226 may also include user assignment instructions which would detail how users requesting the web page of interest are assigned to the different experimental paths created by the experiment design engine 208. For instance, the experimenter may designate that all new users are randomly assigned to one of the available experimental paths created. Alternatively, a predetermined portion of users may be randomly assigned to each experimental path. For instance, if only three experimental paths exist, the experimenter can designate that 50% of users are assigned path A, 30% of users are assigned path B, and 20% of users are assigned path C.

Moreover, user assignment instructions may also comprise instructions on how to re-assign users who have previously been assigned an experimental path. Experimental paths may traverse multiple events over a lengthy time period, where users are requesting the web site repeatedly. A cookie or other identifier may be used to identify repeat users in order to associate them to their previously assigned experimental path.

The experimenter configuration input 226 may also include control group specifications. A portion of users requesting the web site may be assigned to a non-experimental path or a control path, which may be identical for each user assigned to the path. For example, the control specifications 232 may comprise a single path throughout the experiment, such as the original condition of the web pages 204. Alternatively, the control group may include a path at each branch in an experience tree. For example, in creating experimental paths, an experimenter may designate at a particular point, some users will receive web element A, others will receive web element B, while others still may receive web element C. Hypothetically, web element C may comprise a standard treatment and could be designated the control group. Accordingly, depending upon the experiment design, the control specifications may be applied to each one of several events or over the entire experiment experience.

Once the experiment design engine 208 has automatically generated all possible unique experimental paths, the experimenter configuration instructions 226 may identify undesirable experimental paths that should be pruned from the experiment. For example, in generating all possible experimental paths, the experiment design engine 208 may generate a path that includes a description of a snow skiing event with an image of a mountain biking event. Since this particular experimental path may be inconsistent with itself, the experimenter may be able to eliminate it before the experiment is carried out. Furthermore, the experimenter may also choose only a select number of paths to test, dependent upon test objectives, model assumptions and optimization criteria.

Upon receiving the various inputs listed, as well as alternative inputs not enumerated herein, the experiment design engine 208 is able to construct an experiment design 240 comprising multiple experimental paths that may be pushed out to the experiment database for execution by the experiment control engine.

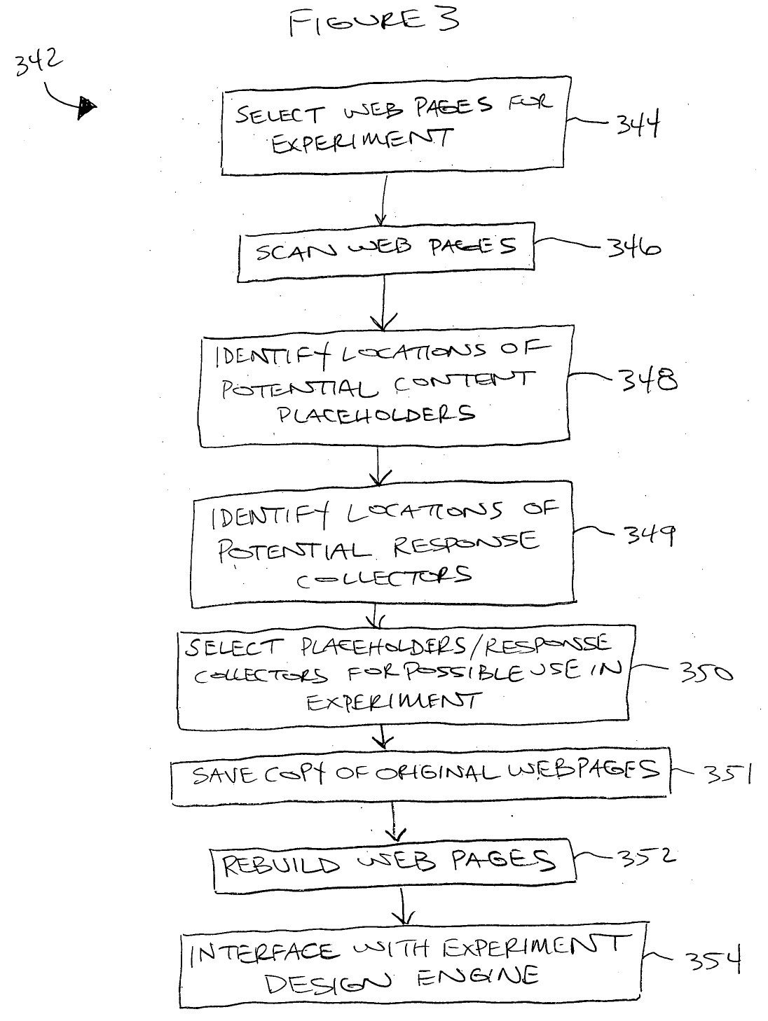

FIG. 3 is a flow diagram of one embodiment of a method for parsing 342 web pages, such as with a web page parsing engine described in conjunction with FIG. 1. The method 342 for parsing may include selecting 344 which web pages are to be included in the experiment. The selecting 344 may be accomplished by the experimenter. For example, for the purposes of marketing analysis and experimentation, the web pages of a corporation's website may be selected 344 for the experiment.

The identified web pages are scanned 346 to identify 348 locations of potential content placeholders and to identify 349 locations of potential response collectors. Identifying content placeholders 348 and response collectors 349 may comprise identifying web elements in the original web pages that can be tagged as a content placeholder or response collector. This process may be automated through a web page parsing engine as heretofore described. The identification 349 of possible response collectors may be associated with user behavior such as the purchasing of a product or service, the aggregate monetary value of purchases, hyperlink clicks, search behavior, inquiries, bookings and reservations, completion of surveys or questionnaires, other data input, etc.

The web page parsing engine may identify 348, 349 a large amount of content placeholders and response collectors. Consequently, the experimenter may select 350 which content placeholders and response collectors should be registered with the experiment design engine for possible use in the experiment. A copy of the original web pages may be saved 351. In certain experiments, it may not be desirable to expose all users of a particular website to an experiment, but rather a small fraction of the users. Consequently, in some embodiments a percentage of users that request the website may see the original saved version of the web pages.

The method 342 for parsing web pages may rebuild 352 the web pages, including creating and embedding content placeholders and response collectors, so the web pages can be experiment enabled and may be configured to conduct specific experiments over the Internet. The parsing engine may then interface 354 with the experiment design engine so that the experiment design engine can construct the experiment with the rebuilt 352 web pages. Interfacing 354 with the experiment design engine may comprise registering all tagged content placeholders and response collectors with the experiment design engine as well as including information about the web address, etc.

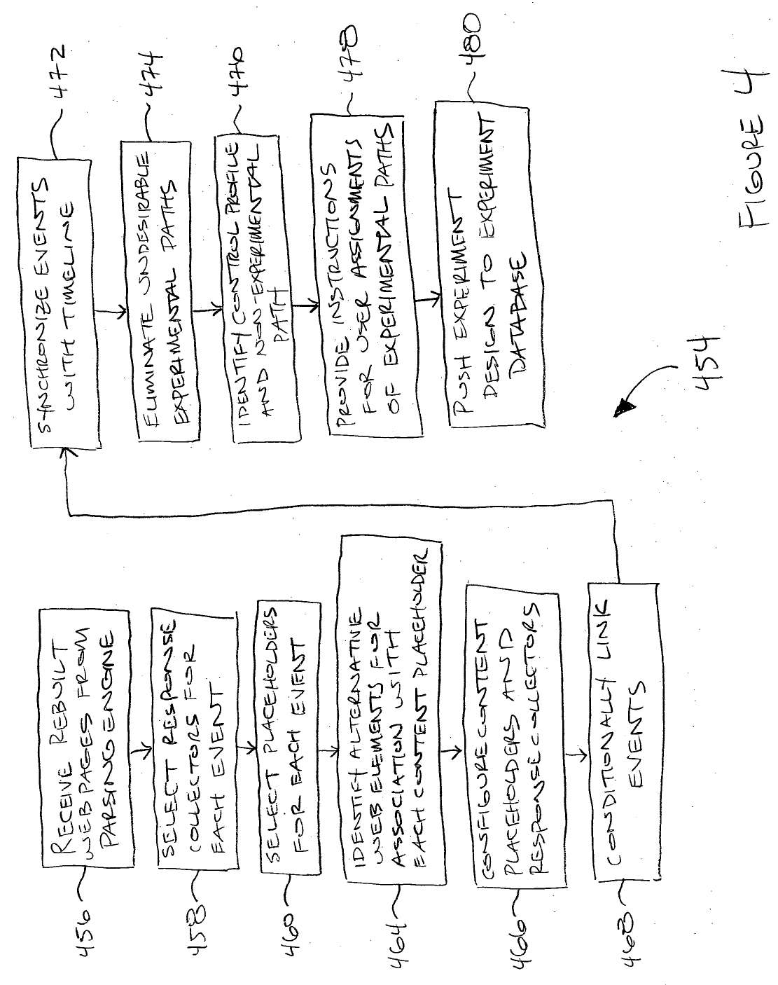

FIG. 4 is a flow diagram of one embodiment of a method 454 for creating an experimental design. As discussed herein, this method 454 may be accomplished through the utility of the experiment design engine. As mentioned in FIG. 3, the experiment design engine may receive 456 the rebuilt web pages from the parsing engine and the accompanying registration information regarding the rebuilt web pages. Using the experiment design engine, the experimenter may select 458 response collectors for each event from those registered by the parsing engine in order to monitor desirable user behavior.

The experiment design engine may also allow an experimenter to select 460 which content placeholders are to be used or enabled with each individual event. The content placeholders selected 460 are typically registered by the parsing engine. In alternative embodiments, the code for the content placeholders may be entered manually and registered manually with the experiment design engine. As discussed above, the content placeholders may be embodied as containers or locations on a web page or series of web pages which define where one of several alternative web elements may appear. The selected 460 content placeholders may be configured and enabled to execute specific experiments and communicate with the experiment control engine, experiment database, and the experiment design engine for future configuration.

The method 454 for creating an experiment design further includes identifying 464 alternative sets of web elements for association with each content placeholder. As discussed above, the various forms of web elements may include, but are not limited to: graphical elements, audio elements, video elements, text elements, and linking elements. The web elements identified 464 may originate from direct user input, i.e., creative content inputted by the experimenter. As discussed earlier, the content placeholders may be associated with combinations of these elements.

The content placeholders and response collectors selected 460, 458 are configured 466 by the experimenter through the experiment design engine to provide instructions on what the content placeholders are going to do during the experiment and to provide instructions to the response collectors on what data they will collect. Content placeholders and response collectors are grouped into a single event in the experiment. Events typically include only one or several content placeholders and one or several response collectors.

Once the various events are configured by grouping and configuring 466 the content placeholders and response collectors associated with each event, the events are linked 468 conditionally to each other and over a common timeline. Unrelated events may be tied to each other to create a series of events or experience. One possible experience through the series of events is an experimental path. Conditional logic may be used to associate various events in some predetermined manner. The conditions are not necessarily based on user behavior, but instead describe the relationship between events. The state of one event may be conditioned upon the state of another event.

Furthermore, events can be synchronized 472 across a common timeline. Events can occur concurrently, at an absolute predetermined time, at a time relative to the state of another event, or at a time relative to the begging or end of the experiment.

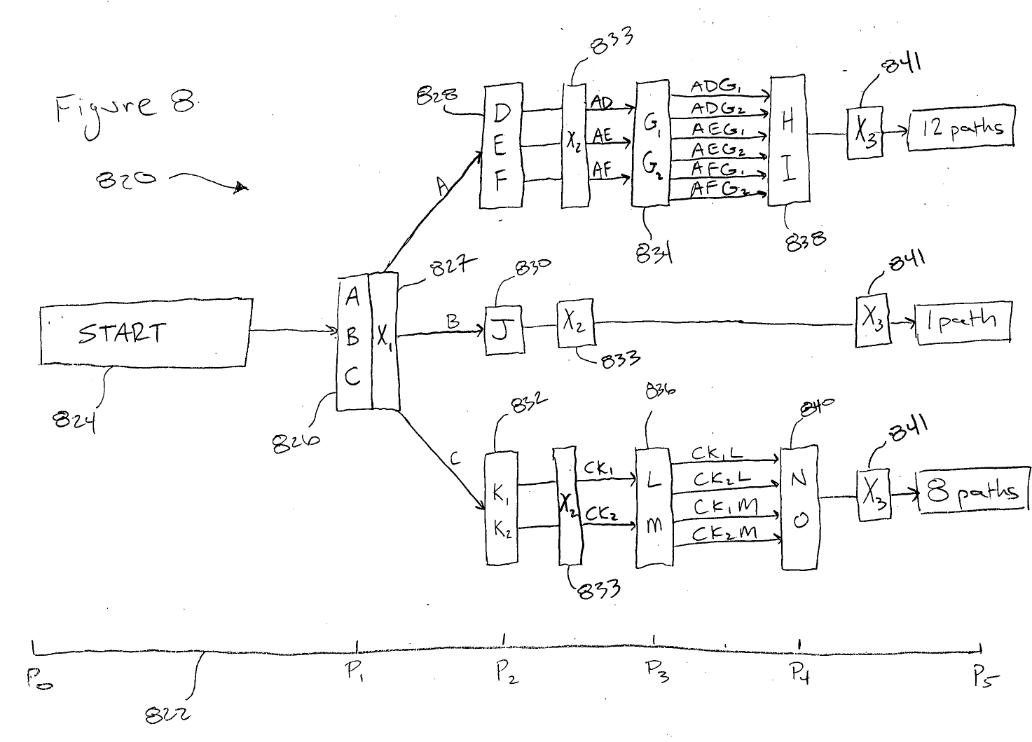

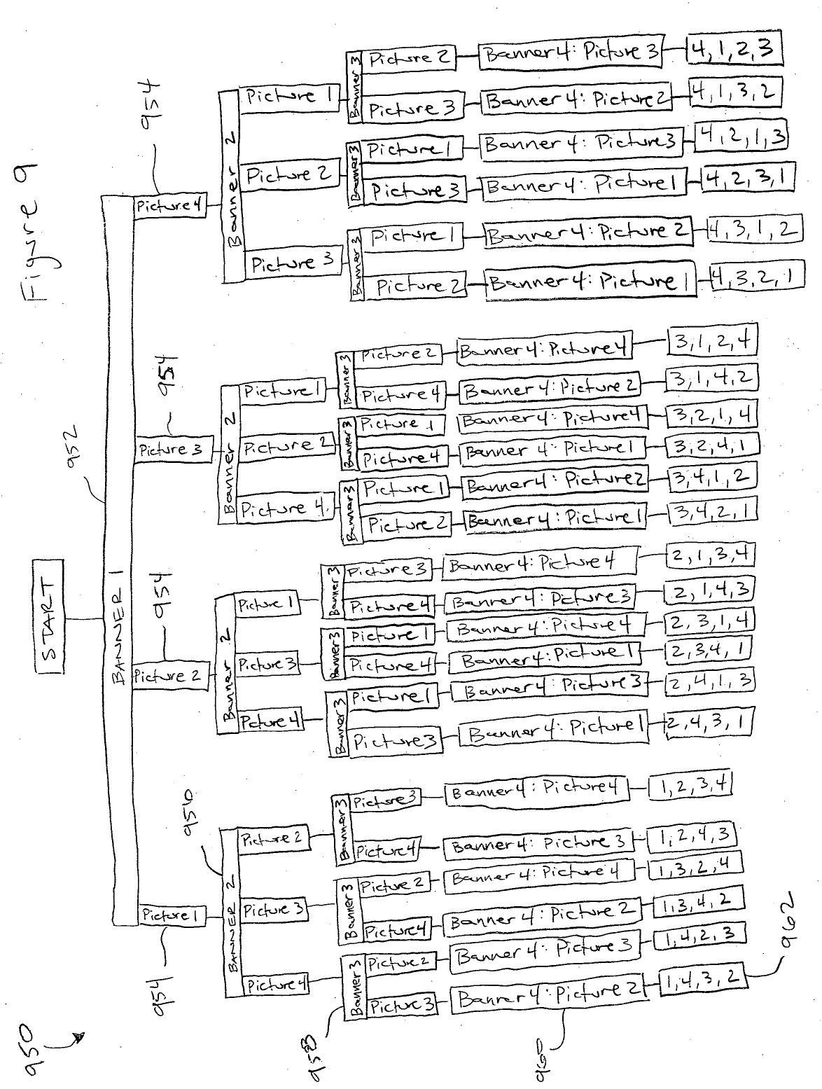

Once the various events are created and the events are linked 468 conditionally and synchronized 472 across the timeline, all possible experimental paths comprising each unique presentation of alternative web elements have been created by the experiment design engine The generation of all possible experimental paths may be illustrated and explained in greater detail in conjunction with FIGS. 8 and 9.

In the automatic generation of all possible experimental paths, some undesirable paths may be created. Accordingly, the undesirable experimental paths may be eliminated 474. As discussed above, by way of example, in generating all possible experimental paths, the experiment design engine may generate a path that includes a text description of a snow skiing event with an inconsistent image of a mountain biking event. The experimenter may then be able to eliminate 474 the undesirable path before the experiment is pushed to the experiment database and the experiment is carried out.

The method 454 may further comprise the step of creating 476 a control profile and/or non-experimental path in accordance with established experimentation techniques. The control profile may comprise a single path throughout the entire website experience, or it may comprise several events at various branches in the experience tree as discussed in greater detail in conjunction with FIG. 8. The non-experimental path may comprise the presentation of the original website.

The method 454 for creating an experiment design may also include an experimenter providing 478 instructions for user assignments of experimental paths. User assignment instructions may detail how users requesting the web page of interest are assigned to the different experimental paths, such as being assigned randomly or according to some predetermined formula. User assignments may also determine the percentage of users that are assigned to a control path or to a non-experimental path.

The experiment design created through the method 454 described is then pushed 480 to the experiment database. The experiment design includes all experimental paths that are to be assigned users during the experiment. As is true with all the methods described herein, the steps and/or actions of the method 454 for creating an experiment design may be interchanged with one another. The order of steps described is not intended to imply a required order.

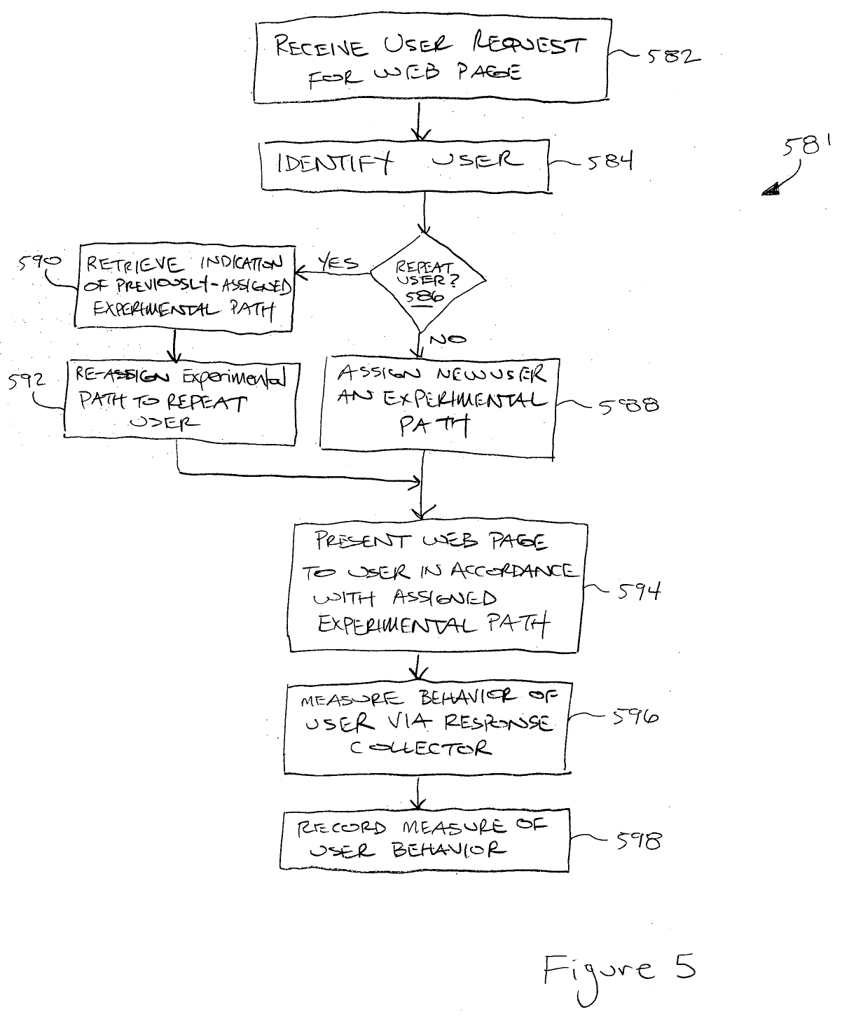

FIG. 5 is a flow diagram of one embodiment of a method 581 for conducting an experiment according to an experimental design, such as the experimental design created as described in conjunction with FIG. 4. The method 581 for conducting the experiment may be accomplished through the experiment control engine described herein. As discussed above, the experiment control engine conducts the experiment in accordance with the design created by the experiment design engine.

The method 581 may commence upon receiving 582 a request from an Internet user for the experimental web pages. The experiment control engine then identifies 584 the user by locating previously-placed cookies on the user's machine and/or other methods for identification known to those having skill in the art. The experiment control engine may then determine 586 whether the requesting user is a repeat user, i.e., has the user already been assigned an experimental path on an earlier visit to the website. Determining 586 whether the user is a repeat user may be accomplished through the user identification 584 step, e.g., locating a previously-placed cookie.

If it is determined 586 that the user is not a repeat user, then the method 581 assumes the user is new and the method assigns 588 the new user to an experimental path in accordance with the assignment instructions provided by the experiment design engine. If it is determined 586 that the user is a repeat user, then the method 581 may include retrieving 590 an indication of the previously-assigned experimental path. The indication of the previously-assigned experimental path may be stored at the experiment database along with the experimental path itself. The repeat user is then re-assigned 592 to the previously-assigned experimental path. The repeat user may then be subjected to similar treatments and a similar web experience that he encountered during an earlier visit to the website.

Once the new or repeat user is assigned 588, 592 his experimental path, a web page is presented 594 to the user in accordance with the assigned experimental path. The series of web pages and web elements presented to the user are all in accordance with the pre-defined experimental path. The behavior of the user is measured 596 through the response collectors that were enabled by the experiment design engine. The measured user behavior may further be recorded 598 in the experiment database as described herein.

Through the method 581 for conducting an experiment and the user behavior that is measured 596 therein, an experimenter is able to identify not only which events of an experimental path affected user behavior, but also how a sequence of events affected user behavior.

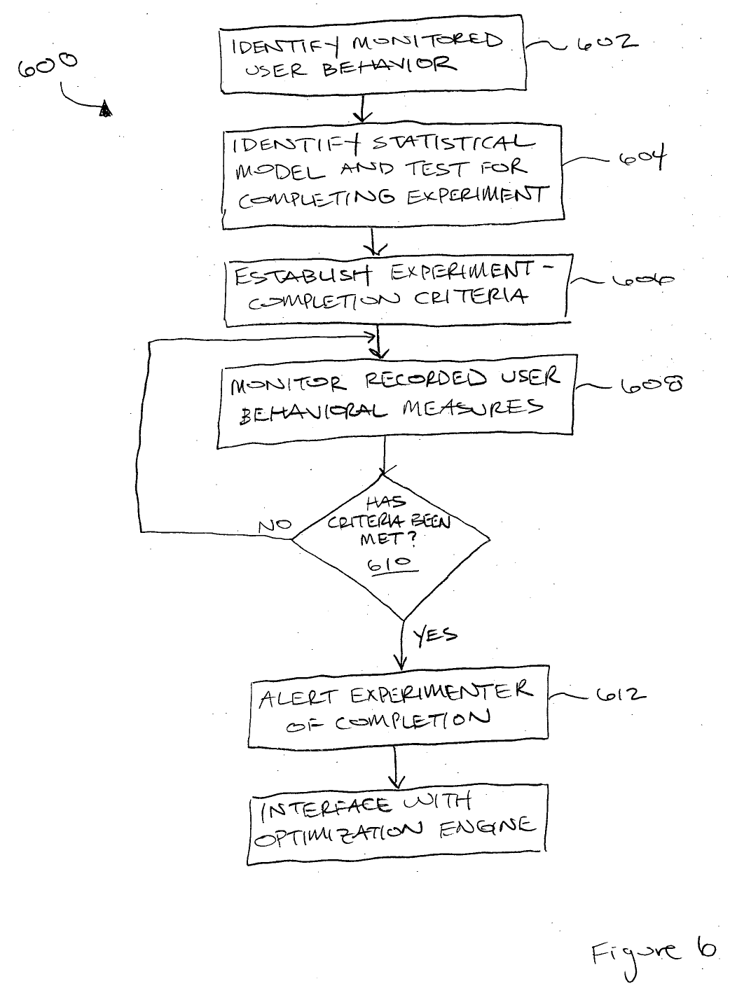

FIG. 6 is a flow diagram of one embodiment of a method 600 for analyzing experiments as they are being conducted and after completion. The method 600 for analyzing experiments may be performed through the experiment analysis engine described herein. The method 600 for analyzing experiments may include identifying 602 the monitored user behavior. The user behavior is recorded to the experiment database from the response collectors. Various forms of user behavior may be monitored and recorded during an experiment.

Based on the identification 602 of monitored user behavior and the hypothesized cause and effect relationship between content and user behavior, the appropriate statistical model and test for completing the experiment are identified 604. Exemplary statistical models include, but are not limited to, OLS regression for continuous response measures, logistic regression for dichotomous objective measures, linear programming, etc.

As with most forms of experimentation, a certain level of uncertainty is inherent in identifying the elements that cause a measured effect. Consequently, to achieve a particular level of statistical confidence or statistical significance with which a cause and effect relationship can be identified, a particular sample size must first be obtained. The required sample size depends upon the model selected and the data obtained.

An experimenter may establish 606 the experiment completing criteria when an experiment can be deemed completed. For example, an experimenter may desire that a 95% or 99% degree of confidence be obtained to identify a particular cause and effect relationship. Therefore, depending on the statistical model, a certain sample size must be obtained before the desired degree of statistical confidence can be reached. Alternatively, the experiment completing criteria may be a particular period of time that the experiment is to run until completion of the experiment. For example, if a 95% degree of confidence is to be obtained, the experiment analysis engine may need a particular time period for experimentation. Alternatively, if the experiment is conducted for a given time period, the experiment analysis engine may provide what level of confidence can be reached for that time period.

The user behavior measures that were recorded by the response collectors are monitored 608 by the experiment analysis engine as they are recorded in the experiment database. It is then determined 610 whether the particular experiment completing criteria has been met. If the criteria has not been met, the method 600 continues to monitor 608 the record user behavioral measures.

If the experiment completing criteria has been met the experimenter may be alerted 612 to this fact. The experiment analysis engine may then interface 614 with the optimization engine to identify and maintain the optimum experimental path.

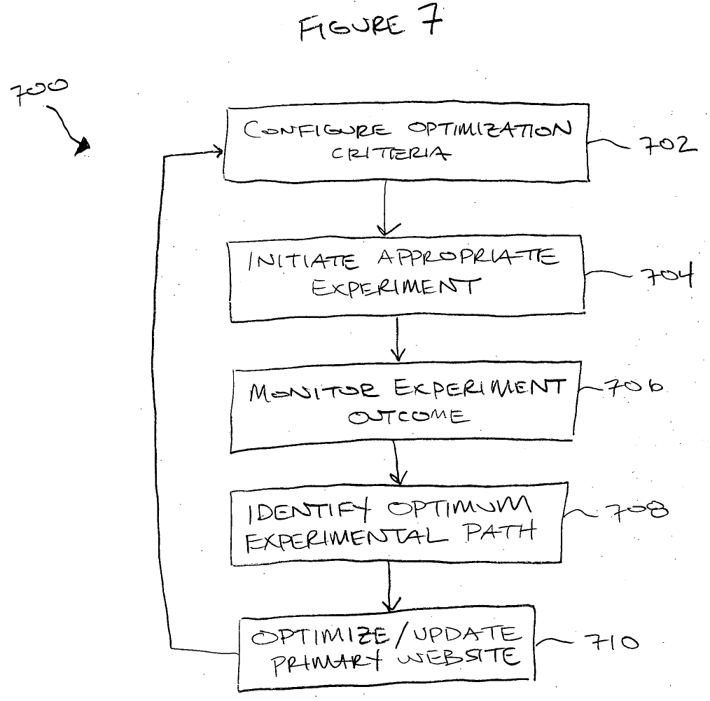

FIG. 7 is a flow diagram of one embodiment of a method 700 for optimizing experimental paths in an experimental design. The method 700 for optimizing experimental paths may be performed through the optimization engine described herein. The method 700 for optimizing identifies an optimum presentation of web elements in a given experiment to achieve a particular objective or set of objectives, i.e., affecting desired user behavior.

According to one embodiment, the method 700 for optimizing includes configuring 702 optimization criteria. Optimization criteria may include how frequently a particular experiment should be conducted and/or the sequence of experiments to be conducted. The experiment database may store several experiment designs that are applied to a set of web pages as configured 702 by the optimization engine.

The optimization engine may initiate 704 the appropriate experiment out of the several experiment designs stored on the experiment database. The experiment control engine conducts the experiment initiated 704 and the experiment analysis engine monitors completion of the experiment.

The optimization engine monitors 706 the outcome of the experiment as provided from the experiment analysis engine. The optimum experimental path is identified 708 by the optimization engine based on the predefined statistical models used in conjunction with the experiment analysis engine. In identifying 708 the optimum experimental path, the optimization engine analyzes the recorded measure of user behavior for one experimental path against all other recorded paths at a particular statistical confidence level.

Once the optimum experimental path is identified 708 (to a degree of predefined statistical significance), the primary website is updated 710 to maintain the optimum experimental path as the default set of web pages for all subsequent users. The experimentation process may discontinued for a predefined time interval, or until new web elements are introduced. However, an experimenter may desire to continue experimentation on a much smaller percentage of users. Therefore, in some embodiments experimentation may be continuously taking place.

An experimenter may wish the optimum experimental path be used as the web page experience for all users for a particular time period. Once the time period expires, it may be desirable to conduct the experiment again to determine if conditions have changed that would make another experimental path more optimal (such as proximity to holidays, etc.). Accordingly, the method 600 for optimizing may again configure 702 optimization criteria depending upon the desired cycling of the experiment.

The optimization engine may coordinate the administration of multiple experiments, each with its own set of experimental paths. An existing experiment may be broken into sub-experiments that are managed by the optimization engine. The triggers used to begin and end any of these experiments may include, for example, time elapsed, absolute time (e.g., each Saturday, beginning of each month, etc.), outcomes of other experiments, etc.

FIG. 8 is a block diagram of one embodiment of an experience design tree 820, representing the various experimental paths within an exemplary hypothetical experiment design. As discussed above, experiences are collections of events that are tied logically together, and optionally synchronized against a common timeline. The experience design tree 820 provides a map of the various experimental paths, but also may be used as a user interface for an experimenter in constructing a design using the experiment design engine.

The experience design tree 820 represents a hypothetical example of one application of the methods and systems disclosed herein. The experience design tree 820 defines a unique set of experiences that are comprised of events that unfold over time. The horizontal axis 822 represents the passage of time in various periods. P₀ represents the start 824 of the experience tree 820, such as when a user requests a web page. The start 824 of an experience tree 820 may alternatively include when a user logs in to a system, or at a specific start time, etc.

By way of example, the web page requested may be a technical support page where the user has requested help with a particular technical problem. Subsequent to requesting the web page, either after a predefined period of time, or immediately after the request, a user will encounter a first event 826 at time period P₁. Depending upon which experimental path the user was assigned, the user will experience one of three alternative web elements.

Element A may represent one alternative web element presented by a content placeholder, such as a text element indicating a failure to resolve the technical problem. Element B may represent a text element indicating success at resolving the problem entered, and is associated with the same content placeholder as Element A. Element C may represent a text element indicating that resolution of the problem has not yet occurred. In some experimental designs, element C could be considered a control group.

Immediately subsequent to the first event 826, a measurement of the user response to each possible experimental path is conducted through a response object. This may be represented graphically by X₁, which is a first response event 827. In the embodiment depicted, first response event X₁ is a separate event from first event 826. By way of example, the measurement (X₁) may comprise a brief customer satisfaction survey. Reponses by each user that is assigned to one of the three branches are also recorded. In alternative embodiments, X₁ may also be considered a component of the first event 826.

The second event may occur during time period P₂. The second event for all users may not occur at exactly the same time, but time period P₂ may represent a time period subsequent to time period P₁. Those users that were assigned element A during the first event 826 will encounter another branch in the experience which represents a second event 828 for path A. Note that because of the conditional logic used in creating the experimental design, only those users that have experienced element A will experience second event 828. Those users that experienced elements B or C will each experience a different second event.

The second event 828 for path A may comprise three alternative web elements, namely D, E and F. By way of example, element D may represent a text element informing the user that outside support will be needed to resolve the technical issue, and the user is told to contact the outside support. Element E may represent a text element informing the user that outside support will be needed, and that current technical support will contact the outside help on behalf of the user in an attempt to resolve the issue. Element F may represent a text or other element that does not inform the user that outside help is being sought. In some experimental designs, element F may be considered a control path.

Those users that were assigned element B during the first event 826 will encounter a second event 830 for path B that is different from those users that experienced elements A or C. The second event 830 for path B may comprise a single web element J or a set of web elements that are the same for all users that are assigned path B. By way of example, element J may be a web element that confirms resolution of the problem.

Due to the conditional logic of the experiment, those users who were assigned element C in the first event 826 will experience second event 832. Second event 832 for path C may comprise two alternative experiences K₁ and K₂. By way of example, K₁ and K₂ may represent no new presentation of web elements, but may represent a different wait time until the users experience the third event. In one embodiment the wait time K₁ is of a shorter duration than wait time K₂. Therefore, some users that were assigned path C will be assigned wait time K₁ and other users assigned path C will be assigned wait time K₂.

Subsequent to the second event for paths A 828, B 830 and C 832, a second response event 833 is conducted to measure user behavior in response to each possible experimental path. This second response event 833 is represented graphically by X₂. The measurement (X₂) may comprise a brief customer satisfaction survey or other form of feedback mechanism. Reponses by each user assigned to each experimental path may also be recorded.

By way of example, the third event for users that were originally assigned paths A or C may occur during time period P₃. Similar to the second event 832 for path C, the third event 834 for users assigned path A may comprise two alternative experiences G₁ and G₂. G₁ and G₂ may represent a different wait time until the users each experience the fourth event. In one embodiment the wait time G₁ is of a shorter duration than wait time G₂. Therefore, some users that were assigned path AD, AE and AF will be assigned wait time G₁ and other users assigned path AD, AE and AF will be assigned wait time G₂. This branch may yield six alternative paths, namely, ADG₁, ADG₂, AEG₁, AEG₂, AFG₁, and AFG₂.

According to the embodiment depicted, those users that were assigned path B may not experience a third (non-response) event because confirmation of resolution of the technical problem was presented during second event 830. However, those users assigned path C may be presented with two alternative elements L and M during third event 836. By way of example, element L may be a text element that informs the user in a terse or offensive manner that resolution of the problem has not been achieved. Element M may be an alternative text element that informs the user in a polite manner that resolution of the problem has not been achieved. Third event 836 produces a branch in the experience tree 820 that may yield four alternative paths, namely, CK₁L, CK₂L, CK₁M and CK₂M.

The fourth event for users that were originally assigned paths A or C may occur during time period P₄. Those users that were originally assigned path A, may all encounter fourth event 838, which comprises the presentation of two alternative web elements H and 1. Again, by way of example, element H may comprise a web element (textual or otherwise) that informs the user that the problem was resolved with outside support. Whereas, those users that were assigned element I may be presented with a web element that informs the user that the problem was not resolved with outside support. Accordingly, fourth event 838 is a branch in the experience tree 820 that yields a total of 12 alternative experimental paths or nodes for those that were originally assigned path A.

On the other hand, those users that were originally assigned path C, may encounter a similar fourth event 840, which comprises the presentation of two alternative web elements N and O. Element N may inform the user that the problem was resolved, while element O may inform the user that the problem was not resolved. Fourth event 840 yields a total of 8 alternative experimental paths or nodes for those users that were originally assigned path C.

User feedback may be measured across all possible experimental paths during the third response event 841 (X₃). Reponses provided by each user assigned to each experimental path are recorded. The hypothetical experiment includes a total of 21 possible experimental paths as demonstrated in the experience tree 820. As discussed above, users may be assigned randomly to each experimental path, or a predetermined percentage of users may be assigned to each particular experimental path. The optimization engine described herein may then use the data recorded to identify which experimental path provides the most positive user responses and use that combination of web elements and series of events as the default for the web pages for subsequent users.

The experience tree 820 described herein may also be used as a graphical interface for the experiment design engine to allow an experimenter to create an experiment as described in conjunction with FIG. 4. The branches of the tree represent events that can occur anywhere along the path. The events can overlap, may be independent, may interact with each other, or follow each other as would be apparent to those having skill in the art with the aid of the present disclosure. Consequently, an experience model comprising multiple events over a time domain enables an experimenter to test hypotheses about the experiment throughout the experience.

Alternative forms of graphical interfaces may be used as would be appreciated by those having skill in the art. For example, a tabular user interface may be used to construct the experiment. In one alternative embodiment, the rows in the table may represent different events, either presented to the user or a measurement of user feedback, while the columns could represent each time period.

FIG. 9 is a block diagram of one embodiment of a single event design tree 950 that is part of an experimental design. The event tree 950 is different from the experience tree 820 of FIG. 8, in that the experience tree 820 represents multiple events, simultaneous or a series over time. The event tree 950 represents all possible unique combinations of web elements created in a single event. Consequently, event tree 950 could replace first event 826 of FIG. 8. The event tree 950 not only is a graphical representation of alternative paths within a single event, but it may also be used as a graphical user interface of the experiment design engine in assisting an experimenter in creating a particular event.

By way of example, a web page may be reconstructed by the parsing engine to contain four different image content placeholders. In a hypothetical experiment, the experimenter wishes to display four different images, but would like to test which arrangement of the images may affect user behavior to the greatest extent. Accordingly, the Banner 1 branch 952 represents the first image placeholder on the web page. Four different pictures or images may be associated with that placeholder. Each alternative image represents a separate branch of the path for this particular event.

In one experimental path, image or picture 1 may be associated with Banner 1 branch 952 as represented by branch 954. Three alternative images may then be associated with the Banner 2 branch 956, which represents the second image placeholder on the web page. Each alternative image represents another branch in the event tree.

If image or picture 4 is associated with the second image placeholder in one experimental path, then there are two alternative images that may be assigned to the third image placeholder, namely picture 2 and picture 3, as represented by the Banner 3 branch 958. Given the same hypothetical experimental path, if image or picture 3 is associated with the third image placeholder, then the only remaining image (picture 2) is associated with the fourth image placeholder as graphically represented by the Banner 4 branch 960.

The nodes 962 of each branch 954 of the event tree represent one alternative presentation of the four image elements that is unique as compared to all the others. In keeping with the hypothetical experimental path discussed previously, the node 962 of the branch 960 described indicates that picture 1 is associated with image placeholder 1, picture 4 is associated with image placeholder 2, picture 3 is associated with image placeholder 3, and picture 2 is associated with image placeholder 4 as represented by the node 962—designated 1, 4, 3, 2.

Consequently, for this particular embodiment of the event tree 950, having four alternative web elements yields a total of twenty four possible combinations for one event. The experimenter can use the experiment design engine to eliminate any of the combinations if they are not desirable for a particular reason. Furthermore, the experimenter may use the experiment design engine to designate what percentage of users will be assigned to a particular branch 954, 956, 958, 960 of the event tree. The experiment control engine may then assign a new user to one of the branches 954, 956, 958, 960 in accordance with the user's assigned experimental path.

The modules depicted in the methods and systems disclosed herein may be implemented using any suitable combination of hardware, software, and/or firmware. In certain embodiments, various modules may be combined or the functionality of certain modules may be divided among two or more modules.

While specific embodiments and applications of various methods and systems for conducting experiments over the Internet have been illustrated and described, it is to be understood that the invention claimed hereinafter is not limited to the precise configuration and components disclosed. Various modifications, changes, and variations apparent to those of skill in the art may be made in the arrangement, operation, and details of the methods and systems disclosed.

Furthermore, the methods disclosed herein comprise one or more steps or actions for performing the described method. The method steps and/or actions may be interchanged with one another. In other words, unless a specific order of steps or actions is required for proper operation of the embodiment, the order and/or use of specific steps and/or actions may be modified without departing from the scope of the invention as claimed.

The embodiments disclosed may include various steps, which may be embodied in machine-executable instructions to be executed by a general-purpose or special-purpose computer (or other electronic device). Alternatively, the steps may be performed by hardware components that contain specific logic for performing the steps, or by any combination of hardware, software, and/or firmware.

Embodiments of the present invention may also be provided as a computer program product including a machine-readable medium having stored thereon instructions that may be used to program a computer (or other electronic device) to perform processes described herein. The machine-readable medium may include, but is not limited to, floppy diskettes, optical disks, CD-ROMs, DVD-ROMs, ROMs, RAMs, EPROMs, EEPROMs, magnetic or optical cards, propagation media or other type of media/machine-readable medium suitable for storing electronic instructions. For example, instructions for performing described processes may be transferred from a remote computer (e.g., a server) to a requesting computer (e.g., a client) by way of data signals embodied in a carrier wave or other propagation medium via a communication link (e.g., network connection).

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill in the art would further appreciate that the various illustrative logical blocks, modules, circuits, and algorithm steps described in connection with the embodiments disclosed herein may be implemented as electronic hardware, computer software, or combinations of both. To illustrate the interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the invention as claimed hereinafter.

What is claimed is:

1. A method for conducting experiments on the internet, comprising:
allowing an experimenter to identify a desired user behavior to monitor;
allowing the experimenter to identify a first set of two or more alternative web elements that may affect the desired user behavior when included in at least one web page;
allowing the experimenter to identify a second set of two or more alternative web elements that may affect the desired user behavior when including in the at least one web page;
automatically creating a plurality of experimental paths to test the impact of the alternative web elements of the first and second sets on the desired user behavior, each experimental path including (1) a version of the at least one web page including a respective one of the alternative web elements from the first set and (2) a version of the at least one web page including a respective one of the alternative web elements from the second set, wherein a presentation to a user of web elements from the second set linked conditionally to a presentation to the user of upon which web elements from the first set;
assigning each of a plurality of users to one of the plurality of experimental paths;
in response to a user request for the at least one web page, presenting the requesting user with the at least one web page in accordance with the assigned experimental path; and
recording a measure of the desired user behavior for each experimental path for the plurality of users.

2. The method of claim 1, wherein assigning comprises randomly assigning a predetermined portion of the plurality of users to each of the experimental paths

3. The method of claim 1, wherein assigning comprises randomly assigning a new user to one of the experimental paths in response to a request by the new user for one of the web pages.

4. The method of claim 3, wherein assigning comprises re-assigning a previously-assigned experimental path to a repeat user in response to a subsequent request for one of the web pages by the repeat user.

5. The method of claim 4, wherein re-assigning comprises:
identifying the repeat user; and
retrieving a stored indication of the experimental path previously-assigned to the repeat user.

6. The method of claim 1, wherein at least one set of the two or more alternative web elements are of the same type.

7. The method of claim 1, wherein at least one set of the two or more alternative web elements include at least two web elements of different types.

8. The method of claim 1, wherein one of the alternative web elements of the first or second set includes at least one of the following: graphical elements, audio elements, video elements, text elements, and linking elements.

9. The method of claim 1, further comprising:
continuing to record the measure of the desired user behavior for each experimental path for the plurality of users for a particular time period.

10. The method of claim 1, further comprising:
continuing to record the measure of the desired user behavior until a specified level of statistical confidence or significance is reached that one of the alternative web elements affects the measure of desired user behavior to a greater degree than the other alternative web elements.

11. The method of claim 1, wherein the presentation to the user of the web element from the second set occurs subsequent to the presentation to the user of the web element from the first set.

12. The method of claim 1, wherein identifying two or more alternative web elements comprises:
parsing the at least one web page to identify one or more locations within the at least one web page to present the alternative web elements; and
allowing a user to specify particular media content to be included as one of the two or more alternative web elements.

13. The method of claim 1, wherein the measure of the desired user behavior comprises a frequency of the desired user behavior.

14. The method of claim 1, wherein the measure of the desired user behavior comprises a frequency of the desired user behavior for each experimental path.

15. The method of claim 1, wherein the user behavior comprises a purchase, and wherein the measure of the desired user behavior comprises an aggregate monetary value of purchases for each experimental path.

16. The method of claim 1, wherein the measure of the desired user behavior comprises a timing of the desired user behavior, for each experimental path, after a user has been presented with the a least one web page.

17. The method of claim 1, wherein within at least one experimental path the presentation of one of the alternative web elements from the second set occurs after a particular time interval following the presentation of one of the alternative web elements from the first set.

18. The method of claim 17, wherein the particular time interval for one experimental path is different from the particular time interval for another experimental path.

19. The method of claim 1, wherein recording the measure of the desired user behavior comprises measuring the user behavior after presentation of one of the alternative web elements from the first set and measuring the user behavior after presentation of one of the alternative web elements from the second set.

20. The method of claim 1, wherein at least one of the plurality of experimental paths includes providing one of the alternative web elements from the first or second set for a particular time period and providing another of the alternative web elements from the other set for a subsequent particular time period.

21. A method for conducting experiments on the internet, comprising:
identifying a desired user behavior in response to at least one web page;
enabling one or more content placeholders for inclusion in the at least one web page;
identifying at least one set of two or more alternative web elements that may affect the desired user behavior when included in the at least one web page;
identifying at least one response collector to measure a desired user behavior;
associating each set of alternative web elements with the placeholder included in the at least one web page;
automatically creating experimental paths for a plurality of users, each experimental path comprising a unique presentation of alternative web elements within the placeholders over the at least one web page;
assigning each of the plurality of users who request the at least one web page to one of the experimental paths;
presenting each requesting user with the at least one web page in accordance with the assigned experimental path; and
recording a measure of the desired user behavior from the at least one response collector for each experimental path for the plurality of users.

22. The method of claim 21, further comprising:
parsing the at least one web page to identify locations of potential content placeholders therein.

23. The method of claim 22, further comprising:
presenting a list of possible content placeholders for selection by an experimenter.

24. The method of claim 21, further comprising:
providing the at least one web page with logic to determine whether a particular user is a new user or a repeat user, and providing the repeat user with a stored indication of the experimental path previously assigned to the repeat user.

25. The method of claim 21, wherein the content placeholders are associated with at least one of the following: graphical elements, audio elements, video elements, text elements, and linking elements.

26. The method of claim 21, wherein one of the content placeholders are associated with two or more alternative offers to be presented to the plurality of users.

27. The method of claim 21, wherein presentation of an alternative web element from a first set of web elements occurs previous to presentation of an alternative web element from a second set of web elements.

28. The method of claim 27, wherein presentation of an alternative web element from a third set occurs concurrently with presentation of alternative web elements from the first set, such that the experimental paths are created, in part, from unique combinations of alternative web elements from the first and third sets.

29. The method of claim 28, wherein the experimental paths are created, in part, from unique combinations of alternative web elements from the first, second and third sets.

30. The method of claim 21, wherein automatically creating the experimental paths comprises creating events conditionally linked to each other over a common timeline.

31. The method of claim 30, wherein presenting one of the alternative web elements from a second set of web elements occurs after a particular time interval following the presentation of one of the alternative web elements from a first set of web elements.

32. The method of claim 31, wherein the particular time interval for one experimental path is different from the particular time interval for another experimental path.

33. The method of claim 30, further comprising conditional logic to present alternative web elements, such that the presentation of web elements is dependent upon a current date of a calendar year.

34. A system to conduct experiments on the internet, comprising:
an experiment design engine to allow an experimenter to identify a desired user behavior to monitor, to allow the experimenter to identify two or more alternative web elements that may affect the desired user behavior when included in at least one web page, and to automatically create a plurality of experimental paths to test the impact of the alternative web elements on the desired user behavior, each experimental path including a version of the at least one web page including a respective one of the alternative web elements;
a distributed experiment control engine within the at least one web page to assign a user to one of the plurality of experimental paths in response to a user request for the at least one web page and to present the requesting user with the at least one web page in accordance with the assigned experimental path; and
an experiment database to record a measure of the desired user behavior for each experimental path for the plurality of users.

35. The system of claim 34, further comprising:
one or more content placeholders for inclusion in the at least one web page, the content placeholder being associated with the two or more alternative web elements as directed by the experiment design engine.

36. The system of claim 35, wherein the one or more content placeholders provide a particular web element to the user in accordance with the assigned experimental path.

37. The system of claim 34, wherein the web elements comprise at least one of the following: graphical elements, audio elements, video elements, text elements, and linking elements.

38. The system of claim 34, further comprising:
a web page parsing engine to parse the at least one web page to identify locations of potential content placeholders therein.

39. The system of claim 34, wherein the distributed experiment control engine is distributed over a plurality of web pages.

40. The system of claim 34, wherein the distributed experiment control engine identifies whether the user is a new user or a repeat user, such that the experiment control engine assigns a new experimental path to the new user and re-assigns a previously-assigned experimental path to the repeat user.

41. The system of claim 34, further comprising:
an optimization engine to identify and maintain an optimum experimental path when a specified level of statistical confidence or significance is reached that one of the experimental paths affects the measure of desired user behavior to a greater degree than the other experimental paths.

42. The system of claim 41, wherein the optimization engine to initiate a repetition of the experiment designed by the experiment design engine after a specified time interval has elapsed from selection of the optimum experimental path.
